(19) United States
(12) Patent Application Publication
(10) Pub. No.: US 2012/0269918 A1
(43) Pub. Date: Oct. 25, 2012

(54) FURNACE FOR CONDITIONING PREFORMS

(75) Inventors: Frank Winzinger, Freising (DE); Christian Holzer, Schierling (DE); Wolfgang Schoenberger, Brennberg (DE); Konrad Senn, Regensburg (DE); Andreas Wutz, Roding (DE)

(73) Assignee: KRONES AG, Neutraubling (DE)

(21) Appl. No.: 13/513,288

(22) PCT Filed: Oct. 20, 2010
(86) PCT No.: PCT/EP2010/006421

§ 371 Date: Jul. 10, 2012

(30) Foreign Application Priority Data
Dec. 4, 2009 (DE) 10 2009 047 540.0

(51) Int. Cl. B29B 13/02; B29C 49/68

(52) U.S. Cl. 425/174.4

(57) ABSTRACT

A rotary furnace for conditioning preforms includes a heating wheel and a plurality of heating modules, each for heating a preform, that are disposed on the heating wheel. Each heating module includes a heating chamber, a holding device for holding the preform and a lifting device. The heating device includes at least one heating radiator adapted for irradiating an outer wall section of the preform with infrared radiation, a recess for introducing the preform, and walls having an insulating layer configured to thermally insulate the heating chamber. The lifting device is configured to raise and lower at least one of the holding device and the heating chamber so as to move the preform into or out of the heating chamber.

### CROSS REFERENCE TO RELATED APPLICATIONS

This application is a U.S. National Phase application under 35 U.S.C. §371 of International Application No. PCT/EP2010/006421, filed on Oct. 20, 2010, and claims benefit to German Patent Application No. DE 10 2009 047 540.0, filed on Dec. 4, 2009. The International Application was published in German on Jun. 9, 2011 as WO 2011/066885 A2 under PCT Article 21 (2).

### FIELD

The invention relates to a furnace of the rotary type for conditioning preforms.

### BACKGROUND

In the blow-moulding or stretch blow-moulding method containers are manufactured from so-called preforms which must be heated to a desired temperature before the actual blow-moulding stage. In order to be able to reshape the rotationally symmetrical preforms, which as a rule have standardised wall thickness values, during blow moulding into a container with a certain shape and wall thickness, individual wall sections of the preform are gradually heated in a furnace, preferably with infrared radiation. Normally, for this purpose a continuous flow of preforms is passed through a furnace with appropriately adapted irradiation sections. One problem with furnaces of this nature is however the targeted transfer of the largest proportion possible of the radiated thermal output into the preforms.

As an alternative to this, the application DE 10 2006 015853 A1 suggests that the preforms are heated in individual irradiation chambers, which in each case enclose the preforms circumferentially, wherein the individual chambers are arranged in the form of a carousel. Here, each preform is heated both by the internal wall of the chamber which is formed as a ceramic infrared radiator and also by a rod-shaped infrared radiator, which is introduced into the preform. As can be taken from a schematic illustration in DE 10 2006 015853 A1, the preform here is completely introduced into the irradiation chamber. However, it remains unresolved as to how the temperature distribution in the individual chambers can be influenced flexibly and as independently as possible from one another, and how the thermal output irradiated into the chamber can be utilised as effectively as possible for heating the preform.

Although the heating chambers in DE 10 2006 015853 A1 are mainly thermally insulated radially towards the outside, they are in direct contact with one another so that heat interchange between the heating chambers is possible. In addition, the chambers are open at the top so that heat can escape uncontrollably and unused. It is however desirable to generate different circumferential and radial temperature profiles controllably and energy efficiently in the heating elements. In this respect there is therefore a requirement for an improved single-chamber furnace.

### SUMMARY

In an embodiment, the present invention provides a rotary furnace for conditioning preforms that includes a heating wheel and a plurality of heating modules, each for heating a preform, that are disposed on the heating wheel. Each heating module includes a heating chamber, a holding device for holding the preform and a lifting device. The heating device includes at least one heating radiator adapted for irradiating an outer wall section of the preform with infrared radiation, a recess for introducing the preform, and walls having an insulating layer configured to thermally insulate the heating chamber. The lifting device is configured to raise and lower at least one of the holding device and the heating chamber so as to move the preform into or out of the heating chamber.

### BRIEF DESCRIPTION OF THE DRAWINGS

Exemplary embodiments of the invention are described in more detail below with reference to the drawings, in which:

FIG. 1 is a schematic plan view of a furnace according to the invention with circumferentially uniformly distributed heating chambers;

FIG. 2 is a schematic longitudinal section through a heating chamber of a first embodiment with a central heating rod introduced into a preform;

FIGS. 3a and 3b show schematic longitudinal sections through variants of the heating chamber;

FIG. 4 is a schematic longitudinal section through an alternative embodiment of the heating chamber according to the invention with a movable shield;

FIG. 5 is a schematic longitudinal section through an alternative variant of the heating chamber with a cooled gripper;

FIGS. 6a and 6b show schematic longitudinal sections through alternative embodiments of the heating chamber according to the invention with a cooling function for the outer wall of the heated preform;

FIG. 7 is a schematic representation of an air cooling system for the interior of the preform heated by a heating mandrel;

FIG. 8 is a plan view of an embodiment of the furnace with air baffle devices for cooling the outer wall of the heating chambers; and

FIG. 9 is a schematic longitudinal section through a heating chamber with temperature sensors.

### DETAILED DESCRIPTION

In an embodiment, the present invention provides a furnace in which the heating chambers can be adapted in the most flexible manner possible and independently of one another to a desired temperature profile of the preforms, both in the circumferential and in the axial directions, and in which heat losses are minimised.

Due to the fact that, in embodiments of the present invention, the walls of the heating chamber, in particular a bottom wall of the heating chamber oppositely situated to a recess for introducing the perform and a side wall bordering the bottom wall of the heating chamber, comprise an insulating layer, the circumferential and axial heating profiles of the individual heating chambers can be flexibly adapted to the respective requirement independently of one another. In addition heating losses are reduced.

Materials suitable for the insulating layer are preferably plastics, in particular PET, polyethylene, polystyrene, Neopor or polyurethane, but also aluminium, in particular composite aluminium, ceramics, mineral fibres such as glass or rock wool, ceramic film as composites with other materials, wood or cork. Other conceivable materials would be cellulose composite systems, hemp, flax, coconut or reed panels. Mineral foams such as foam mortar, pumice stone, perlite, swelling clay, expanded mica, calcium silicate or foamed glass can also be used. Composites comprising any selection of the mentioned materials would also be conceivable.

Preferably a lid is provided on the recess of the heating chamber in order to close the heating chamber to insulate it thermally in the uncharged state. In this way the temperature variations in the heating chamber are minimised and thermal losses further reduced.

In an embodiment the holding device comprises at least one gripper element, which can be cooled by a liquid and/or air stream, for holding and cooling a mouth region of the preform during irradiation. In this way it can be ensured that the mouth region, which should remain unchanged during the blow moulding process, is not inadmissibly heated, so that adequate stability of the mouth region during the irradiation and the subsequent blow moulding process is ensured.

Preferably at least one ventilation inlet is provided on the holding device for blowing in cooling air eccentrically into the preform in order to pass the blown-in cooling air essentially on the inner side of the preform wall. In this way the situation can be avoided in that the inner side of the preform heats up disproportionately in comparison to a central wall section or to the outer side of the preform.

In an embodiment at least one ventilation inlet on the heating chamber for introducing a cooling air flow and one ventilation outlet for discharging the air flow are provided in order to pass cooling air along the outer side of the preform wall. In this way the situation can be avoided in that the outer side of the preform heats up disproportionately in comparison to a central wall section or to the inner side of the preform.

Preferably the heating chamber and the holding device are pivotably supported with respect to one another in order to swirl the cooling air flow in the heating chamber and/or to pass it along the preform in a helical manner. In this way the surface of the preform can be uniformly cooled circumferentially.

In an embodiment at least one temperature probe is provided in the heating chamber for determining an inner temperature, whereby the furnace further comprises a control unit for adjusting an infrared heating power and/or a cooling air flow in the heating chamber based on the determined inner temperature. In this way a chronological progression of the heating of the preform is adjusted in the heating chamber and/or a certain temperature level is maintained in the heating chamber.

An embodiment of the invention furthermore comprises air baffle devices, which are tilted towards a direction of rotation of the heating wheel and/or are curved in order to pass air, which is built up by the rotation of the heating wheel, against the heating chambers. In this way a cooling air flow can be realised without the use of an additional blower. The path of the air flow can also be controlled by specific shaping of the air baffle devices.

Preferably the heating chamber comprises at least one heating radiator in the form of a heating coil embedded in a ceramic layer, whereby the ceramic layer is adapted for an emission in the range from 2 to 3.5 μm. Due to the ceramic layer a radiating surface which is larger and more uniform in comparison to the heating coil can be provided and the spectral range of the radiated heat radiation and its spatial distribution can be adapted to produce a desired temperature distribution in the preform. In the wavelength range from 2 to 3.5 μm a particularly greater proportion of the incident heat radiation is absorbed in the preform so that the heating can be concentrated very well onto a certain wall section.

In a particularly embodiment the heating chamber comprises at least one heating radiator in the form of a bright (high intensity/point source) radiator with a radiation maximum at a wavelength of less than 2 μm, especially a brightly emitting halogen radiator, a brightly emitting light-emitting diode and/or a brightly emitting laser. Due to less inertia, radiators of this nature can be particularly precisely controlled with respect to time and facilitate adaptation of the irradiation spectrum to various preform materials and material thickness values. Due to the comparatively low absorption in the wall of the preform, the bright radiation can excite a passive radiator arranged on the rear side of the irradiated wall.

Preferably the heating modules furthermore each comprise a heating rod for irradiating an inner wall section of the preform with infrared radiation, whereby the device is furthermore adapted for raising and lowering the holding device and/or the heating rod, in order to introduce the heating rod into the preform or to withdraw the heating rod from it. With the additional heating rod the wall of the preform can be irradiated and heated particularly uniformly over its whole thickness. Additionally, in this way wall sections can be irradiated, in particular in the vicinity of the mouth region of the preform, which can only be inadequately irradiated by the outer heat radiator. The lifting device also simplifies the axial profiling of the preform by targeted irradiation of axial sections of the preform.

In an embodiment the heating modules also comprise a thermally insulating housing for the heating rod, in which the heating rod can be withdrawn whereby in particular a lid is provided on the housing in order to close the housing, providing thermal insulation when the heating rod is withdrawn. In this way heating losses can be minimised when the heating rod is withdrawn. In addition, it is possible to reduce temperature variations of the heating rod.

Preferably, several radiators are provided in the longitudinal direction on the heating rod with different and/or separately adjustable heating power. Thus, axial thermal profiling of the preform wall, in particular on its inner side, can be facilitated by selective activation of the individual radiators. Additionally, time-variation of the axial profiling is possible without moving the heating rod in the preform.

Preferably, at least one ceramic layer for the radiation of infrared light is provided on the heating rod, in particular for the conversion of bright radiation with a radiation maximum at a wavelength of less than 2 μm to a longer wavelength radiation with a wavelength in the range of 2 to 3.5 μm. In this way it is possible to operate the heating rod completely or partially passively in that incident bright radiation from the outer side of the preform passes through its wall onto the heating rod where it is converted into a radiation which is particularly effective for heating the inner side of the preform.

In an embodiment a radiation shield, which can be cooled by a liquid and/or air flow is provided on the heating rod and/or on the holding device in order to shield and/or cool the mouth section against the infrared radiation emitted by the heating rod. In this way excessive heating of the mouth region is prevented, in particular in order to ensure stable holding of the preform in the heating chamber and for a stable shape of the mouth region during the blow-moulding process.

In another embodiment the heating chambers are thermally insulated from one another.

In a further embodiment the heating chambers are only thermally insulated towards the outside and are in thermally interchanging contact with one another.

In a further embodiment the mouth regions of the preforms are directly cooled with an air flow. This air flow can be formed by a blower inside or outside the furnace and can pass through pipes to the areas to be cooled.

In a further embodiment the heating chambers are each cooled by a separate blower.

In an alternative embodiment the preforms are accommodated in the heating chamber without being suspended and instead stand in the perpendicular direction with the mouth region facing downwards.

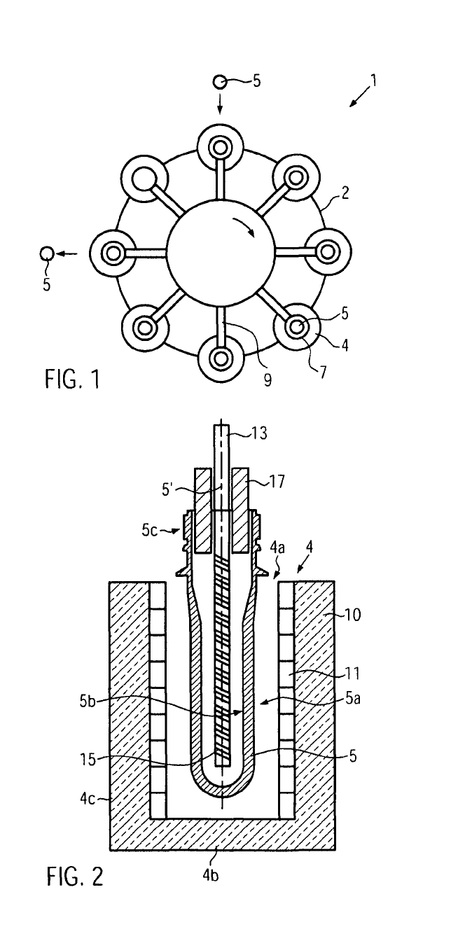

As can be seen from FIG. 1, the furnace 1 according to the invention is designed as a rotary machine and comprises a pivotably supported heating wheel 2, on which circumferentially uniformly distributed heating modules 3 are arranged, the number of which can deviate from the illustrated example and each of which comprises a heating chamber 4 for heating in each case one preform 5 as well as a holding device 7 for holding the preform 5, whereby the holding device 7 can be moved by a lifting device 9 at least in the axial direction with regard to the longitudinal axis 5′ of the preform 5. The holding devices 7 and the lifting devices 9 are adapted such that each of them can transfer a preform 5 from a conventional infeed star (not illustrated) and lower it into the heating chamber 4. Furthermore, the heated preform 5 can be transferred from the holding device 7 and from the lifting device 9 to a conventional discharge star (not illustrated) for the further processing of the preform 5.

As illustrated in FIG. 2, an insulating layer 10 is provided on each of the heating chambers 4. The insulating layer 10 encloses the heating chamber 4 preferably with an opening 4a of the heating chamber for introducing the preform 5 into the heating chamber 4. In particular, the heating chamber 4 is enclosed by the insulating layer 10 fully circumferentially with regard to the principal axis 5′ of the preform 5 to be introduced. In this way heat interchange between the heating chambers 4 of the individual heating modules 3 is largely avoided.

Furthermore, in the heating chamber 4 at least one heating element 11 is provided for the irradiation of the outer side 5a of the preform 5. FIG. 2 furthermore shows an optional heating rod 13, which can be lowered into the preform 5 using the lifting device 9. On the heating rod 13 at least one heating element or radiator 15 is provided for irradiating the inner side 5b of the preform 5, whereby the radiators 15 (eight of them in the example) are preferably controllable separately. The holding device 7 is not illustrated in FIG. 2 for the sake of clarity. In FIG. 2 a sleeve-like shielding element 17 is also indicated, which surrounds the heating rod 13 in an annular manner and which optically and thermally shields the mouth region 5c of the preform 5 against the heating rod 13. For this purpose the shielding element 17 can be cooled by an air flow or a liquid.

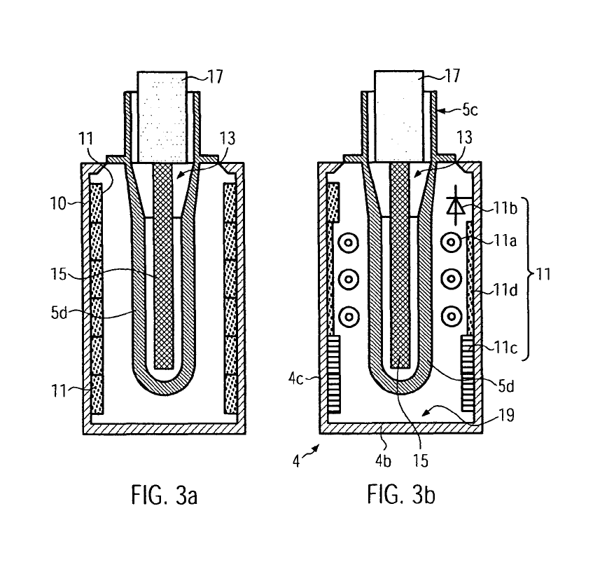

FIGS. 3a and 3b show different variants of the heating elements 11 and 15, which can be combined together as required depending on the embodiment. For the sake of clarity the insulating layer 10 is only indicated.

In FIG. 3a several heating elements 11 of the heating chamber 4 are, for example, formed as annular functional ceramics stacked axially one above the other. They are preferably each heated actively with a wire coil (not illustrated). The heating elements 11 radiate preferably in the wavelength range from 2 to 3.5 μm.

On the heating rod 13 of FIG. 3a a radiator or heating element 15, also in the form of a functional ceramic with active heating, is formed by a wire coil (not illustrated). The preferred spectral range for the heating element 15 of the heating rod 13 lies between 2 and 3.5 μm. However, a plurality of annular heating elements 15 could be stacked one above the other in the axial direction on the heating rod 13.

With the variant in FIG. 3b on the other hand a heating element 15 is provided on the heating rod 13 in the form of a passive functional ceramic. Passive means in this connection that the heating element 15 is not provided with its own power supply, but instead either reflects and/or converts heat radiation coming into the heating chamber 4 into heat radiation with a longer wavelength. This is particularly advantageous if at least one of the heating elements 11 is formed as a bright radiator, the radiation of which is absorbed comparatively weakly in the wall 5d of the preform 5, so that the heating element 15 can be efficiently irradiated with bright radiation also through the wall 5d. The radiation emitted by the passive radiator 15 then has preferably a longer wavelength and is absorbed to a comparatively large extent in the wall 5d of the preform 5.

In FIG. 3b different variants of the radiators 11 are also indicated, for example bright radiators 11a in the form of halogen radiators and a light emitting diode 11b, which are each characterised in that they exhibit a radiation maximum at a wavelength of less than 2 μm. Alternatively, a laser would also be suitable as a bright radiator. Also indicated are a second functional ceramic 11c, which can for example be designed as a passive functional ceramic for the conversion of an incident wavelength of heat radiation into radiation of a longer wavelength, and an active functional ceramic 11d, heated with a heating coil and with a specially adapted spectral radiation characteristic. The different variants of the heating radiator 11 can be combined together as required to heat circumferential or axial partial regions of the preform 5 with a selected radiation characteristic.

FIGS. 3a and 3b show the shielding element 17 with which the mouth region 5c of the preform 5 is protected against excessive irradiation. At the places where no heating radiator 11 is provided the inner side of the heating chamber 4b, 4c is preferably provided with a coating 19 which reflects the heat radiation.

The heating radiators 11 and 15 could also radiate electromagnetic radiation in a different wavelength range, for example microwave radiation, as an alternative to infrared radiation. Furthermore, the radiators are not restricted to the illustrated rotationally symmetrical shapes. In particular, various radiators 11, 15 can also be formed just as circumferential segments, for example annular segments for the circumferentially selective profiling of the preforms 5, i.e. so-called preferential heating.

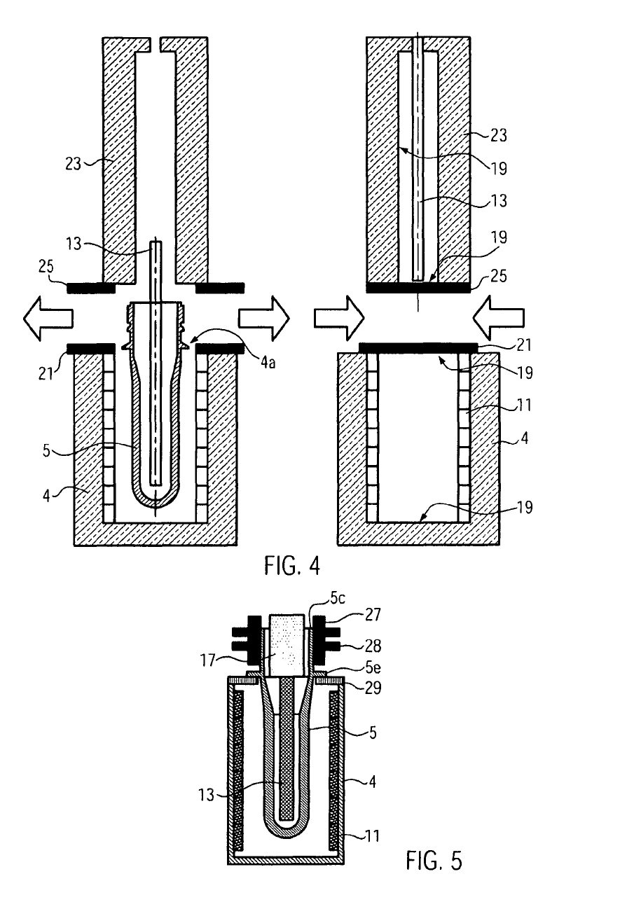

FIG. 4 shows a variant of the heating module 3 for which on the heating chamber 4 a lid 21 is provided with which the opening 4a of the uncharged heating chamber 4 can be closed, as indicated on the right side of FIG. 4. For comparison on the left side of FIG. 4 the heating chamber 4 is shown charged with a preform 5. The lid 21 is preferably implemented such that it is thermally insulating and reflects heat radiation. In addition for the heating rod 13 a thermally insulating housing 23 is provided on which a lid 25 is formed, which can be closed when the heating chamber 4 is not charged, so that the heating rod 13 which is withdrawn into the housing 23 is protected, thermally insulated and reflecting heat radiation, from cooling down.

Preferably, a layer 19, which reflects infrared radiation, is provided on the inner side of the housing 23 and the lids 21 and 25. The lids 21 and 25 could be implemented as one part and, for example, for closing the heating chamber 4 or the housing 23 by pivoting in front of them. They can however also be implemented as several parts and, for example as indicated in FIG. 4 by block arrows, moved apart or together. For the sake of clarity the associated actuating mechanisms and the mounting of the heating rod 13 are not shown.

With closures of this nature for the heating chambers 4 and the housings 23 heating of the chambers 4 or the heating rods 13 after the furnace 1 is switched on could be speeded up to achieve the operating temperature.

In FIG. 5 a holding device 7 with a cooled gripper 27 is illustrated, which encloses the mouth region 5c of the preform 5 pincer-like from outside. Alternatively, it would also be possible to form a gripper 27 on the holding device 7 which holds the mouth region 5c from the inside. As indicated in FIG. 5, the gripper 27 is preferably provided with cooling fins 28 to cool the gripper 27 from outside by convection, in particular with air. However, liquid cooling would also be conceivable in which a cooling liquid flows through the gripper similar to a cooling collar. The sleeve-like shielding element 17 is preferably cooled similarly, for example by a cooling liquid flow or an air flow.

A base plate of the heating chamber 4 for a supporting ring 5e formed on the preform 5 can be formed as a cooled protective shield 29, whereby the gripper 27 could be brought into thermally conducting contact (not illustrated) with the protective shield 29 in order to cool the gripper 27 with the aid of the protective shield 29. In addition the gripper 27 can be formed such that it is in thermally conducting contact with the sleeve-like shielding element 17, so that both the gripper 27 and the shielding element 17 can be cooled with the aid of the cooling shield 29. This is particularly advantageous for reducing the number of feed lines for the cooling liquid and/or cooling air.

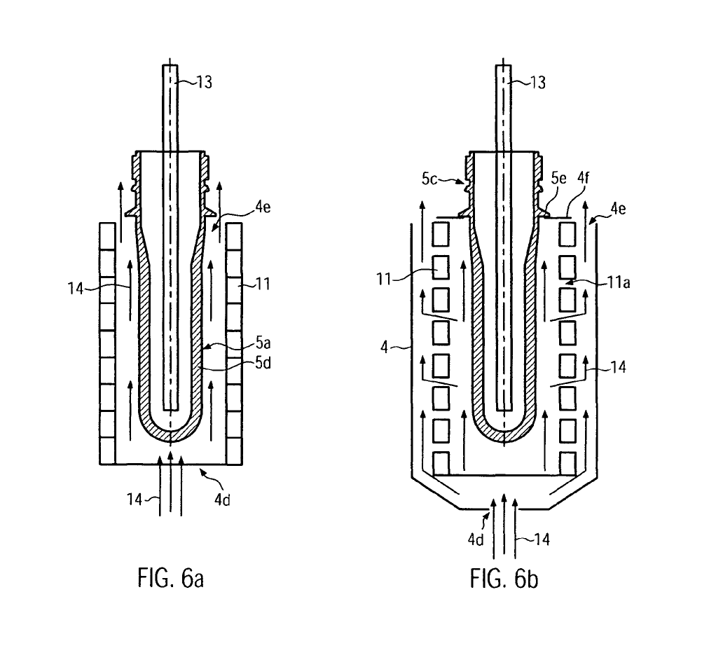

FIGS. 6a and 6b show variants of the heating chamber 4 with active cooling of the outer side 5a of the preform 5 by introducing a cooling air flow 14, symbolised in each case by arrows.

In the variant of FIG. 6a the cooling air flow 14 is passed from below through a recess 4d in the wall 4b of the heating chamber 4. As can also be seen in FIG. 6a the cooling air flow 14 is essentially passed along the surface 5a of the preform 5 and exits the heating chamber 4 through the recesses 4e, which for example can be provided on the base plate 4f for the supporting ring 5e of the preform 5.

In the variant of FIG. 6b an intervening space 11a is provided in each case between the heater elements 11, through which the cooling air flow 14 introduced from below can escape to the outside. In this case the recesses 4e are preferably arranged such that the air flow 14 is passed radially outside of the heating elements 11 through the base plate 4f. Depending on the cooling of the mouth region 5c of the preform 5, either the variant of FIG. 6a or the variant of FIG. 6b can be particularly advantageous. The cooling indicated in FIGS. 6a and 6b is advantageous when a surface region of the wall 5d of the preform 5 is heated by the effect of the heat radiation excessively in comparison to a central wall section, in particular when long-wave infrared radiation is used which is absorbed in the wall 5d particularly well. In order to distribute the cooling effect as uniformly as possible over the surface 5a of the preform 5, it is advantageous if the preform 5 is rotated relative to the heating chamber 4. Similarly, it would be possible to introduce the cooling air flow 14 such that it is passed around the preform 5 essentially in a helical path. The direction of the cooling air flow 14 could also be reversed, i.e. passing from top to bottom in the drawings 6a and 6b.

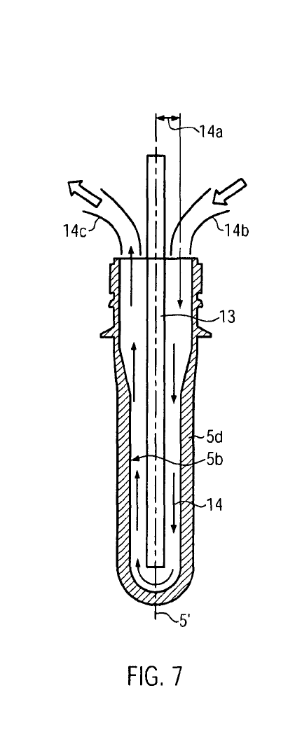

FIG. 7 shows a variant in which the inner side 5b of the preform 5 is actively cooled by a cooling air flow 14. For the sake of simplicity the heating chamber 4 is not illustrated here. As can be seen from FIG. 7, the cooling air flow 14 is introduced into the preform 5 from above asymmetrically at a distance 14a to the principal axis 5′ of the preform on one side of the heating rod 13 and passed along the heating rod 13 or the inner side 5b. As is also indicated in FIG. 7, the cooling air flow 14 is passed back to the outside through the circumferentially opposing side of the preform 5. With the illustrated air cooling system the inner wall 5b of the preform 5 can be cooled to avoid excessive heating of a surface region of the wall 5d of the preform 5 due to the effects of the heat radiation emitted by the heating rod 13 in comparison to a central wall section. This can be advantageous in particular with the effects of long-wave infrared radiation.

With the arrangement illustrated in FIG. 7 it is advantageous if the preform 5 rotates with respect to the heating rod 13 and the cooling air feed 14b as well as the cooling air exhaust 14c. In this way a cooling air flow 14, which is marked in FIG. 7 by arrows, can be passed along the wall 5b of the preform 5 especially uniformly. In addition, in particular with long preforms 5, it can be expedient to provide additional extraction at the cooling air exit 14c for the specific discharge of the cooling air flow 14. For the sake of clarity this is not illustrated.

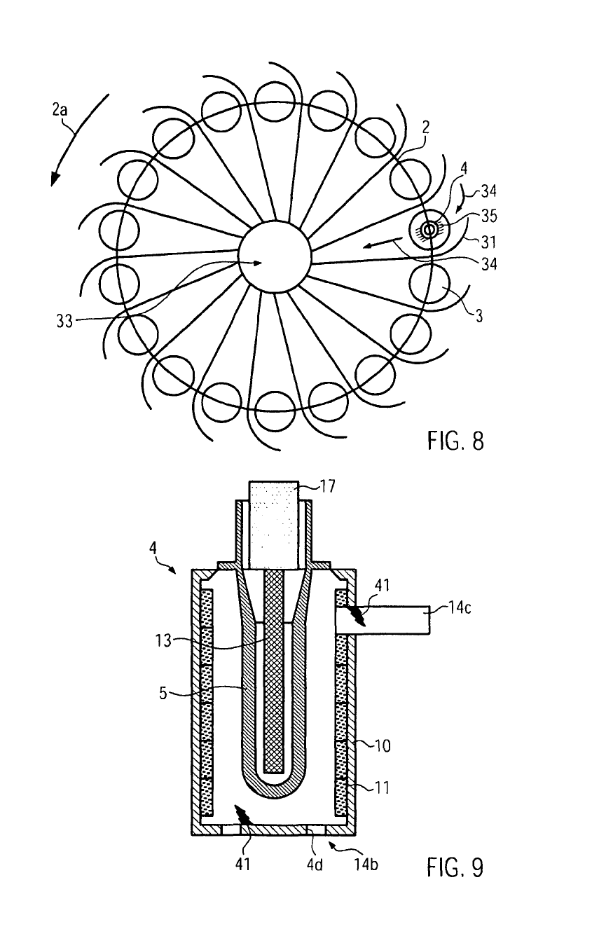

FIG. 8 shows an embodiment of the furnace 1 according to the invention in which the heating chambers 4 or the heating modules 3 are cooled by feeding a cooling air flow 34 while the heating wheel 2 is rotated. For this purpose air baffle devices 31 are provided on the heating wheel 2, respectively assigned to the heating modules 3, for example, suitably shaped walls or channels, which in particular can be formed as air baffles. These are curved and/or tilted in the direction of rotation 2a of the heating wheel 2 so that when the heating wheel 2 is rotated built-up air is passed as a cooling air flow 34 through the air baffle devices 31 in the direction of the heating modules 3. As indicated in FIG. 8, the air baffle devices 31 function like paddle-wheels, whereby the cooling air 34 is led past the heating modules 3 and discharged through a central collecting well 33. In order to improve the effect of the cooling air flow 34, cooling fins 35 can be formed on the heating chambers 4. Cooling of this nature can be advantageous, although the heating chambers 4 are thermally insulated. Residual heat can be dissipated in this way and kept away from thermally sensitive assemblies. In addition the cooling air flow 34 can be used to cool the holding device 7, the grippers 27, the protective shield 17 and/or the mouth region 5c of the preform 5. Alternatively or additionally to the illustrated air cooling system, it would also be possible to cool the heating chambers 4 with a liquid cooling system.

FIG. 9 shows another variant of the heating chamber 4 in which temperature probes 41 are additionally provided. These can, for example, be provided in the vicinity of the recesses 4d of the feed line 14b or on the discharge line 14c of the cooling air 14. With the temperature probes 41 it is possible to monitor the temperature within the heating chambers 4. Similarly, it is conceivable that with the aid of the temperature probes 41 and a suitable control device the amount of cooling air introduced into the heating chamber 4 can be controlled, in particular with convection driven by a blower. However, this would also be possible with free convection. A temperature control can also be used to stabilise the heat distribution in the preform and/or to compensate differences between individual heating chambers 4 or preforms 5. It is also conceivable to regulate the amount of air to be introduced in dependence of a measured final temperature after heating the preform and/or to mix discharged cooling air 14 for temperature control at least partly with the cooling air 14 to be fed in and/or to pass the discharged cooling air 14 to a heat exchanger for heat extraction in another process.

With the aid of temperature probes 41 the temperature in the heating chambers 4, in particular after closing the lid 21 with the heating chamber 4 uncharged, can be set to a constant value or to a uniform output temperature for heating the preforms 5.

The features of the described embodiments and variants can be combined as required. In particular different variants of the irradiation, insulation and cooling can be combined.

While the invention has been particularly shown and described with reference to preferred embodiments thereof, it will be understood by those skilled in the art that various changes in form and details may be made therein without departing from the spirit and scope of the invention.

1-15. (canceled)

16. A rotary furnace for conditioning preforms comprising:
a heating wheel; and
a plurality of heating modules, each for heating a preform, disposed on the heating wheel, each heating module including:
a heating chamber including at least one heating radiator adapted for irradiating an outer wall section of the preform with infrared radiation, a recess for introducing the preform, and walls having an insulating layer configured to thermally insulate the heating chamber,
a holding device configured to hold the preform, and
a lifting device configured to raise and lower at least one of the holding device and the heating chamber so as to move the preform into or out of the heating chamber.

17. The furnace recited in claim 16, wherein the rotary furnace is configured for stretch blowing plastic containers.

18. The furnace recited in claim 16, wherein the walls having an insulating layer include a bottom wall of the heating chamber opposite the recess and a side wall bordering the bottom wall.

19. The furnace recited in claim 16, further comprising a lid disposed on the recess of the heating chamber so as to close the heating chamber thermally insulated in an uncharged state.

20. The furnace recited in claim 16, wherein the holding device includes at least one gripper element configured to be cooled by at least one of liquid and air flow, the at least one gripper element being configured to hold and cool a mouth region of the preform during the irradiation.

21. The furnace recited in claim 16, wherein the holding deice includes at least one ventilation inlet adapted for blowing cooling air eccentrically into the preform so as to pass the blown-in cooling air substantially along an inner side of a wall of the preform.

22. The furnace recited in claim 16, wherein the heating chamber includes at least one on ventilation inlet adapted for introducing a cooling air flow and at least one ventilation outlet adapted for discharging the air flow, the at least one ventilation inlet and at least one ventilation outlet being configured to pass cooling air along an outer side of a wall of the preform.

23. The furnace recited in claim 22, wherein the heating chamber and the holding device are pivotably supported with respect to one another so as to at least one of swirl the cooling air flow in the heating chamber and to pass the cooling air flow along the preform in a helical manner.

24. The furnace recited in claim 16, further comprising:
at least one temperature probe disposed in the heating chamber and adapted to determine an inner temperature, and
a control unit configured to at least one on of an infrared heating power and a cooling air flow in the heating chamber based on determined inner temperature.

25. The furnace recited in claim 16, further comprising air baffle devices that are at least one of tilted and curved towards a direction of rotation of the heating wheel so as to pass air, which builds up by rotation of the heating wheel, against the heating chambers.

26. The furnace recited in claim 16, wherein the heating chamber includes at least one heating radiator including a heating coil embedded in a ceramic layer, the ceramic layer being adapted for emission in a range from 2 to 3.5 μm.

27. The furnace recited in claim 16, wherein the hating chamber includes at least one heating radiator including a bright radiator with a radiation maximum at a wavelength of less than 2 μm.

28. The furnace recited in claim 27, wherein the bright radiator includes at least one of a brightly emitting halogen radiator, a brightly emitting light-emitting diode and a brightly emitting laser.

29. The furnace recited in claim 16, wherein each heating module includes a heating rod for irradiating an inner walls section of the preform with infrared radiation, and wherein at least one of the lifting device and the heating rod is adapted to introduce the heating rod into the preform or withdraw the heating rod from the preform.

30. The furnace recited in claim 29, wherein each heating module includes a thermally insulating housing for the heating rod, from which the heating rod can be withdrawn.

31. The furnace recited in claim 30, wherein housing includes a lid configured to close the housing and provide thermal insulation when the heating rod is withdrawn.

32. The furnace recited in claim 29, further comprising a plurality of radiators disposed in a longitudinal direction of the heating rod, the plurality of radiators having at least one of different and separately adjustable heating power.

33. The furnace recited in claim 29, wherein at least one ceramic layer for the radiation of infrared light is disposed on the heating rod.

34. The furnace recited in claim 33, wherein the at least one ceramic layer is adapted for the conversion of bright radiation with a radiation maximum at a wavelength of less than 2 μm to a longer wavelength radiation with a wavelength in a range of 2 to 3.5 μm.

35. The furnace recited in claim 29, wherein a radiation shield adapted to be cooled by at least one of liquid and air flow is disposed on at least one of the heating rod and the holding device, the radiation shield being configured to at least one of shield and cool a mouth section against infrared radiation emitted by the heating rod.
